(19) United States
(12) Patent Application Publication
(10) Pub. No.: US 2026/0012634 A1
(43) Pub. Date: Jan. 8, 2026

(54) ENCODING DEVICE, DECODING DEVICE, AND NON-TRANSITORY MACHINE-READABLE MEDIUM FOR ENCODING/DECODING VIDEO DATA

(71) Applicant: SHARP KABUSHIKI KAISHA, Osaka (JP)

(72) Inventors: KAI-WEN LIANG, New Taipei City (TW); Yu-chiao Yang, New Taipei City (TW)

(21) Appl. No.: 19/260,396

(22) Filed: Jul. 4, 2025

Related U.S. Application Data
(60) Provisional application No. 63/667,981, filed on Jul. 5, 2024.

(51) Int. Cl. H04N 19/513; H04N 19/105; H04N 19/139; H04N 19/176; H04N 19/196

(52) U.S. Cl. CPC H04N 19/521; H04N 19/105; H04N 19/139; H04N 19/176; H04N 19/196

(57) ABSTRACT

An electronic device and a corresponding method for decoding/encoding video data is provided. The electronic device includes at least one processor and at least one non-transitory computer-readable medium coupled to the at least one processor and storing one or more computer-executable instructions that, when executed by the at least one processor, cause the electronic device to: receive the video data; determine a block unit from an image frame based on the video data; determine, based on a vector sum of multiple motion vectors of multiple reference blocks, a motion shift that indicates a collocated block for the block unit; determine multiple predicted samples of the block unit based on motion information of the collocated block; and reconstruct the block unit based on the predicted samples of the block unit. In addition, a non-transitory machine-readable medium for decoding/encoding video data is also provided.

### CROSS-REFERENCE TO RELATED APPLICATION(S)

The present disclosure claims the benefit of and priority to U.S. Provisional Patent Application Ser. No. 63/667,981, filed on Jul. 5, 2024, entitled “IMPROVEMENTS TO TEMPORAL-BASED PREDICTION TOOLS,” the content of which is hereby incorporated herein fully by reference in its entirety into the present disclosure for all purposes.

### FIELD

The present disclosure is generally related to video coding and, more specifically, to techniques for determining motion information used in predictions.

### BACKGROUND

Prediction is a fundamental technique of video coding, enabling efficient compression by reducing spatial and temporal redundancies in video sequences. A prediction mechanism is categorized into two primary methods: intra prediction and inter prediction. Intra prediction utilizes spatial redundancies within a single frame by predicting target blocks based on neighboring blocks. Inter prediction, on the other hand, leverages temporal redundancies by predicting a target block in the current frame using reference blocks from other frames.

A key aspect of inter prediction is the construction of a candidate list, which consists of motion vectors that represent possible motion relationships between reference and target blocks. The candidate list serves as the basis for selecting the motion vector that provides the most accurate prediction for each block. However, the quality and completeness of the candidate list can significantly affect the efficiency of inter prediction. Suboptimal candidate lists may fail to capture complex motion patterns, resulting in higher residual errors and increased bitrate requirements. This challenge becomes more pronounced in dynamic video content or high-resolution sequences, where accurately predicting motion is particularly difficult.

Over the years, various methods have been developed to construct candidate lists, often focusing on common patterns or simplifying assumptions about motion. While these approaches have achieved some improvements, they may still fall short in scenarios with unconventional or intricate motion characteristics. There remains an opportunity to enhance the construction of candidate lists by incorporating strategies that better address such complexities, thereby furthering the improvement of the coding efficiency and compression performance in video coding systems.

### SUMMARY

The present disclosure is directed to a device and method for determining motion information used in predictions, aimed at improving prediction accuracy and enhancing coding efficiency in video decoding.

In a first aspect of the present disclosure, an electronic device for decoding video data is provided. The electronic device includes at least one processor, and at least one non-transitory computer-readable medium coupled to the at least one processor and storing one or more computer-executable instructions. The one or more computer-executable instructions, when executed by the at least one processor, cause the electronic device to: receive the video data; determine a block unit from an image frame based on the video data; determine, based on a vector sum of multiple motion vectors of multiple reference blocks, a motion shift that indicates a collocated block for the block unit; determine multiple predicted samples of the block unit based on motion information of the collocated block; and reconstruct the block unit based on the predicted samples of the block unit.

In an implementation of the first aspect, determining the motion shift includes: determine a first neighboring block spatially or temporally neighboring the block unit; determine a first multiple reference blocks, among the reference blocks, based on motion information of the first neighboring block; and determine the motion shift based on a first multiple motion vectors of the first multiple reference blocks.

In another implementation of the first aspect, determining the first neighboring block includes: calculating multiple template matching costs of multiple neighboring blocks of the block unit; and selecting the first neighboring block from the multiple neighboring blocks, such that to the first neighboring block is associated with a smallest template matching cost among the multiple template matching costs.

In another implementation of the first aspect, the motion information of the first neighboring block includes a block vector.

In another implementation of the first aspect, determining the first neighboring block includes: selecting the first neighboring block from multiple adjacent blocks of the block unit and multiple non-adjacent blocks of the block unit.

In another implementation of the first aspect, determining the motion shift further includes: determine a second neighboring block spatially or temporarily neighboring the block unit; determine a second multiple reference blocks, among the multiple reference blocks, based on the motion information of the second neighboring block; and determine the motion shift based on the first multiple motion vectors of the first multiple reference blocks and a second multiple motion vectors of the second multiple reference blocks.

In another implementation of the first aspect, determining the first multiple reference blocks includes: determining a first reference block, among the first multiple reference blocks, based on the motion information of the first neighboring block; and determining a second reference block, among the first multiple reference blocks, based on a first motion vector, among the first multiple motion vectors, of the first reference block.

In another implementation of the first aspect, the first reference block is determined by performing a template matching method based on the first neighboring block and the motion information of the first neighboring block, and the second reference block is determined by performing the template matching method based on the first reference block and the first motion vector.

In another implementation of the first aspect, determining the multiple predicted samples of the block unit based on motion information of the collocated block includes: determining, based on the motion information of the collocated block, a motion field at a subblock level; and determining the multiple predicted samples of the block unit based on a subblock-based temporal motion vector prediction method and the motion field.

In a second aspect of the present disclosure, an electronic device for encoding video data is provided. The electronic device includes at least one processor, and at least one non-transitory computer-readable medium coupled to the at least one processor and storing one or more computer-executable instructions. The one or more computer-executable instructions, when executed by the at least one processor, cause the electronic device to: receive the video data; determine a block unit from an image frame based on the video data; determine, based on a vector sum of multiple motion vectors of multiple reference blocks, a motion shift that indicates a collocated block for the block unit; determine multiple predicted samples of the block unit based on motion information of the collocated block; and reconstruct the block unit based on the predicted samples of the block unit.

In an implementation of the second aspect, determining the motion shift includes: determine a first neighboring block spatially or temporally neighboring the block unit; determine a first multiple reference blocks, among the reference blocks, based on motion information of the first neighboring block; and determine the motion shift based on a first multiple motion vectors of the first multiple reference blocks.

In another implementation of the second aspect, determining the first neighboring block includes: calculating multiple template matching costs of multiple neighboring blocks of the block unit; and selecting the first neighboring block from the multiple neighboring blocks, such that the first neighboring block is associated with a smallest template matching cost among the multiple template matching costs.

In another implementation of the second aspect, the motion information of the first neighboring block includes a block vector.

In another implementation of the second aspect, determining the first neighboring block includes: selecting the first neighboring block from multiple adjacent blocks of the block unit and multiple non-adjacent blocks of the block unit.

In another implementation of the second aspect, determining the motion shift further includes: determine a second neighboring block spatially or temporarily neighboring the block unit; determine a second multiple reference blocks, among the multiple reference blocks, based on the motion information of the second neighboring block; and determine the motion shift based on the first multiple motion vectors of the first multiple reference blocks and a second multiple motion vectors of the second multiple reference blocks.

In another implementation of the second aspect, determining the first multiple reference blocks includes: determining a first reference block, among the first multiple reference blocks, based on the motion information of the first neighboring block; and determining a second reference block, among the first multiple reference blocks, based on a first motion vector, among the first multiple motion vectors, of the first reference block.

In another implementation of the second aspect, the first reference block is determined by performing a template matching method based on the first neighboring block and the motion information of the first neighboring block, and the second reference block is determined by performing the template matching method based on the first reference block and the first motion vector.

In another implementation of the second aspect, determining the multiple predicted samples of the block unit based on motion information of the collocated block includes: determining, based on the motion information of the collocated block, a motion field at a subblock level; and determining, based on a subblock-based temporal motion vector prediction method, the multiple predicted samples of the block unit based on a subblock-based temporal motion vector prediction method and the motion field.

In a third aspect of the present disclosure, non-transitory machine-readable medium of an electronic device storing one or more computer-executable instructions for decoding video data is provided. The one or more computer-executable instructions, when executed by at least one processor of the electronic device, cause the electronic device to: receive the video data; determine a block unit from an image frame based on the video data; determine, based on a vector sum of multiple motion vectors of multiple reference blocks, a motion shift that indicates a collocated block for the block unit; determine multiple predicted samples of the block unit based on motion information of the collocated block; and reconstruct the block unit based on the predicted samples of the block unit.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of this disclosure.

FIG. 2 is a block diagram illustrating a decoder module of the second electronic device illustrated in FIG. 1, in accordance with one or more example implementations of this disclosure.

FIG. 3 is a flowchart illustrating a method/process for decoding and/or encoding video data by an electronic device, in accordance with one or more example implementations of this disclosure.

FIG. 4 is a diagram illustrating a determination of a motion shift for a block unit, in accordance with one or more example implementations of this disclosure.

FIG. 5 is a diagram illustrating multiple adjacent blocks of a block unit, in accordance with one or more example implementations of this disclosure.

FIG. 6 is a diagram illustrating multiple adjacent and non-adjacent blocks of a block unit, in accordance with one or more example implementations of this disclosure.

FIG. 7 illustrates how a template matching cost for a neighboring block of a block unit is calculated, in accordance with one or more example implementations of this disclosure.

FIG. 8 is a diagram illustrating a determination of multiple motion shifts for a block unit, in accordance with one or more example implementations of this disclosure.

FIG. 9 is a block diagram illustrating an encoder module of the first electronic device illustrated in FIG. 1, in accordance with one or more example implementations of this disclosure.

### DETAILED DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and case of understanding, features are identified (although, in some examples, not illustrated) by reference designators in the exemplary figures. However, the features in different implementations may differ in other respects and shall not be narrowly confined to what is illustrated in the figures.

The present disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on a computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium.

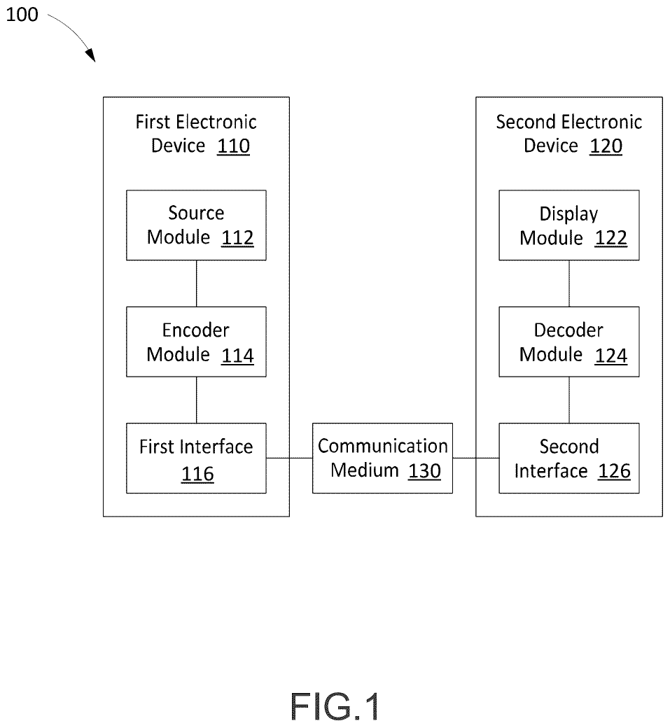

FIG. 1 is a block diagram illustrating a system 100 having a first electronic device and a second electronic device for encoding and decoding video data, in accordance with one or more example implementations of this disclosure.

The system 100 includes a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any one of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIc) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

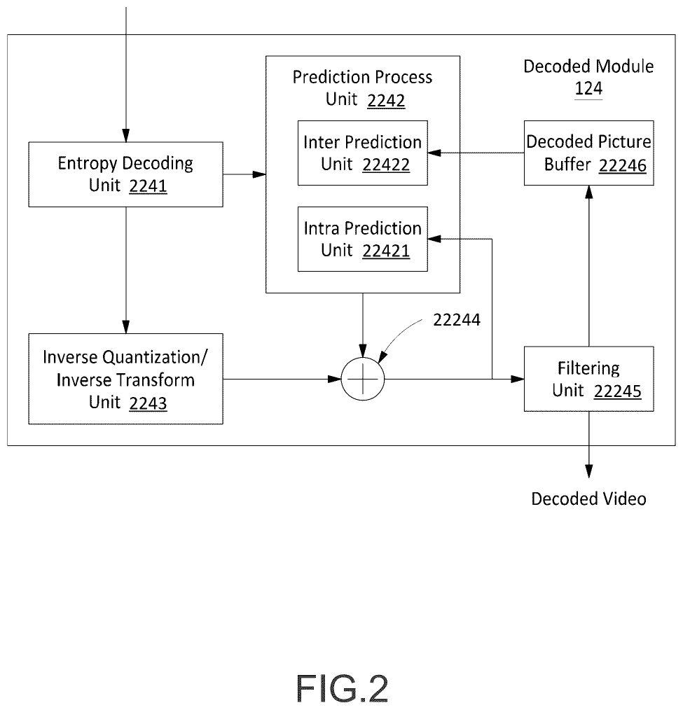

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames according to the partition information.

Each of the image frames may be divided into at least one image block according to the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame as the current block unit based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components is reconstructed by the prediction processing unit 2242.

The intra prediction unit 22421 may reconstruct multiple chroma components of the current block unit based on the multiple luma components of the current block unit when the multiple luma components of the current block unit is reconstructed by the prediction processing unit 2242.

The inter prediction unit 22422 may perform inter-predictive coding of the current block unit relative to one or more blocks in one or more reference image blocks based on syntax elements related to the motion vector in order to generate the predicted block.

The motion vector may indicate a displacement of the current block unit within the current image block relative to a reference block unit within the reference image block. The reference block unit may be a block (e.g., in a reference frame) determined to closely match the current block unit.

The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block to the predicted block provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove the blocking artifacts from the reconstructed block. Additional filters (in loop or post loop) may also be used in addition to the deblocking filter, the SAO filter, the bilateral filter, and the ALF. Such filters (which are not explicitly illustrated for the brevity of description) may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any one of a variety of memory devices, such as a dynamic random-access memory (DRAM), including synchronous DRAM (SDRAM), magneto-resistive RAM (MRAM), resistive RAM (RRAM), or other types of memory devices. The decoded picture buffer 2246 may be on-chip along with other components of the decoder module 124 or may be off-chip relative to those components.

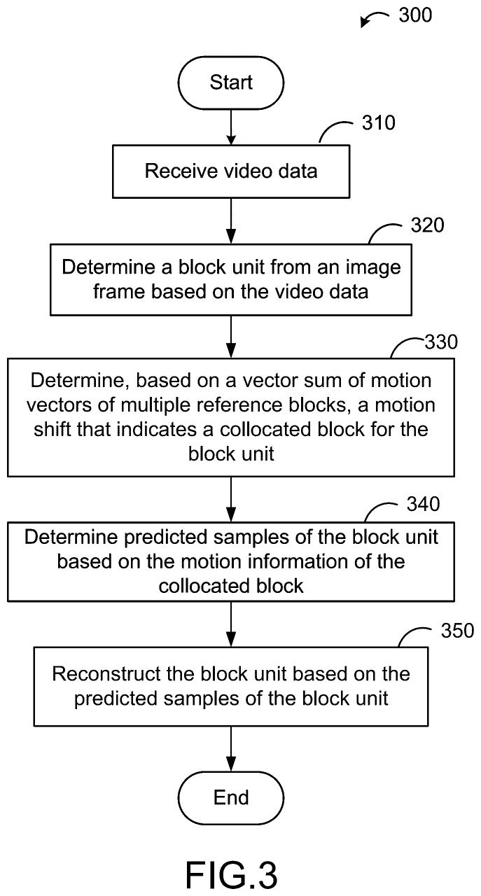

FIG. 3 is a flowchart illustrating a method/process 300 for decoding and/or encoding video data by an electronic device, in accordance with one or more example implementations of this disclosure. The method/process 300 is an example implementation, as there may be a variety of methods of decoding the video data.

The method/process 300 may be performed by an electronic device, such as the electronic device 110 or electronic device 120, using the configurations illustrated in FIGS. 1 and 2, where various elements of these figures may be referenced to describe the method/process 300. Each block illustrated in FIG. 3 may represent one or more processes, methods, or subroutines performed by an electronic device.

The order in which the blocks appear in FIG. 3 is for illustration only, and may not be construed to limit the scope of the present disclosure, thus may be different from what is illustrated. Additional blocks may be added or fewer blocks may be utilized without departing from the scope of the present disclosure.

At block 310, the method/process 300 may start by receiving (e.g., by the decoder module 124) the video data. The video data received by the decoder module 124 may include a bitstream provided by the encoder module 114, which may include information of multiple image frames.

With reference to FIG. 1 and FIG. 2, the second electronic device 120 may receive the bitstream from an encoder, such as the first electronic device 110, or from other video providers, via the second interface 126. The second interface 126 may provide the bitstream to the decoder module 124.

The entropy decoding unit 2241 may decode the bitstream to determine multiple prediction indications and multiple partitioning indications for multiple video images. Then, the decoder module 124 may further reconstruct the multiple video images based on the prediction indications and the partitioning indications. The prediction indications and the partitioning indications may include multiple flags and multiple indices.

At block 320, the method/process 300 may determine (e.g., by the decoder module 124), a block unit from an image frame based on the video data. Specifically, the video data may include the bitstream received from the encoder, and a block unit may be determined from an image frame of the bitstream.

With reference to FIG. 1 and FIG. 2, the decoder module 124 may determine the image frames based on the bitstream and may divide each image frame to determine the block units according to the partition indications in the bitstream. For example, the decoder module 124 may divide the image frames to generate multiple CTUs, and further divide one of the CTUs to determine the block units according to the partition indications using any video coding standard.

In some implementations, the block unit may be a current block. For example, the current block may include at least one of a coding unit, a prediction unit, a macroblock, a luma block, and a chrome block.

At block 330, the method/process 300 may determine (e.g., by the decoder module 124), based on a vector sum of multiple motion vectors of multiple reference blocks, a motion shift that indicates a collocated block for the block unit. Specifically, the decoder module 124, starting from at least one neighboring block of the block unit, may recursively find multiple reference blocks in multiple reference frames based on motion information of each reference block. The motion shift may then be determined based on a vector sum of the motion vectors of the reference blocks, and may indicate a collocated block of the block unit in a collocated frame. For example, the motion shift, starting from a neighboring block, may end at the collocated block of the block unit. The motion information may, for example, include a motion vector.

In some implementations, the decoder module 124 may determine a first neighboring block of the block unit. Based on the motion information (e.g., motion vector or block vector) of the first neighboring block, the decoder module 124 may determine a first reference block in a first reference frame. Based on the motion information (e.g., motion vector) of the first reference block, the decoder module 124 may determine a second reference block in a second reference frame. Performing the aforementioned method recursively, a number of reference blocks may be determined. The determined number of the reference blocks may be preset in the decoder module 124 or may be parsed from the bitstream. The number of reference blocks may correspond to the number of recursive layers. A vector sum of the motion/block vector of the first neighboring block and the motion vectors of the first plurality of reference blocks may then be used for determining the motion shift of the block unit. The motion shift may indicate a collocated block of the block unit. In some implementations, the motion shift may be included in a candidate list of an inter-prediction mode, such as a subblock-based temporal motion vector prediction (SbTMVP) mode described in VVC or ECM. In some implementations, a reference index indicating the first neighboring block of the block unit may be added to the candidate list with the motion shift.

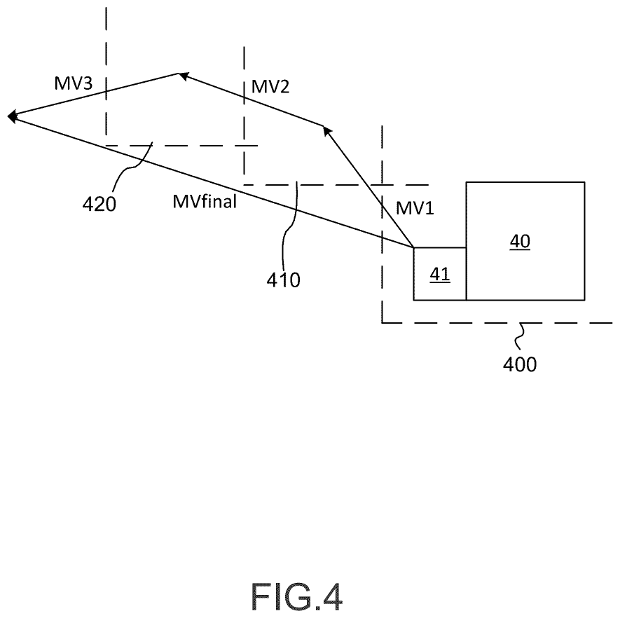

FIG. 4 is a diagram illustrating a determination of a motion shift for a block unit, in accordance with one or more example implementations of this disclosure.

As shown in FIG. 4, a first neighboring block 41 of the block unit 40 may be determined. The first neighboring block 41 may be, for example, in the current image frame 400, where the block unit 40 is. Based on the block/motion vector MV1 of the first neighboring block 41, a first reference block (not shown) in a first reference frame 410 may be determined. Based on the motion vector MV2 of the first reference block in the first reference frame 410, a second reference block (not shown) in a second reference frame 420 may be determined, such that a motion vector MV3 is associated with the second reference block. A motion shift MVfinal may be determined based on a vector sum of the vectors MV1, MV2, and MV3. It should be noted that, in a case that the first neighboring block 41 is associated with a block vector, the first reference frame 410 may be identical to the current image frame 400.

It should also be noted that the number of reference blocks and associated temporal layers used for determining the motion shift, in this disclosure, is exemplified as two (or three when the current image frame is taken into account). However, the number of reference blocks and associated temporal layers used for determining the motion shift is not limited to two (or three). A person of ordinary skill in the art may apply the method described with reference to FIG. 4 to recursively determine additional reference blocks and their corresponding motion vectors when the number exceeds two.

In some implementations, a reference block (e.g., a first reference block or a second reference block) may be determined based on a motion vector associated with a preceding block (e.g., a first neighboring block or a second reference block). For example, the motion vector of the preceding block may indicate the spatial and/or temporal location of the reference block in a reference frame. In some implementations, a template matching method may be performed to refine the motion vector of the preceding block in order to search in the reference frame for a better motion vector to indicate the reference block. The template matching method may search within a predefined range around the motion vector of the preceding block to find a refined motion vector that minimizes the template matching (TM) cost between a current template and a reference template. In some implementations, the refined motion vector for the preceding block (e.g., the first neighboring block or the second reference block) may indicate the reference block (e.g., the first reference block or the second reference block).

In some implementations, the first neighboring block of the block unit may be selected, from the neighboring blocks of the block unit, for determining an initial guide vector (e.g., block/motion vector associated with the first neighboring block) that indicates a first reference block in a first reference frame.

In some implementations, neighboring blocks of the block unit may include blocks that are temporally neighboring the block unit. Specifically, a temporally neighboring block of the block unit may indicate a block that is located in a different temporal layer or a reference frame, such as a previously decoded frame. The temporally neighboring block may, for example, spatially correspond to the block unit, for example, by occupying the same or a proximate spatial position in the reference frame.

In some implementations, neighboring blocks of the block unit may include blocks that are spatially neighboring the block unit. Specifically, a spatially neighboring block of the block unit may indicate one of multiple adjacent blocks of the block unit or one of multiple non-adjacent blocks of the block unit (e.g., pre-defined depending on the coding standard or implementation).

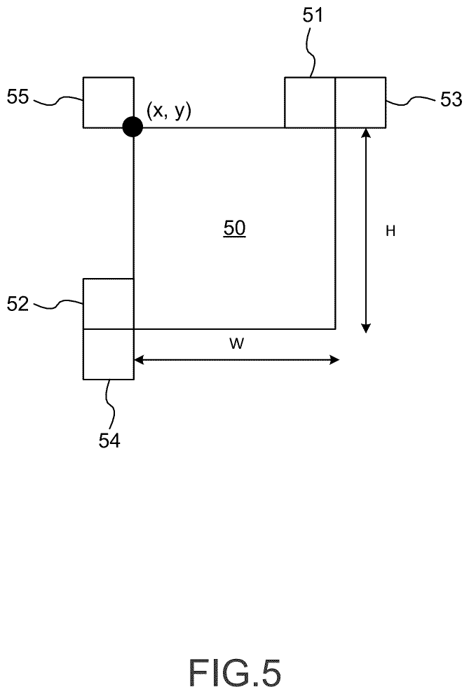

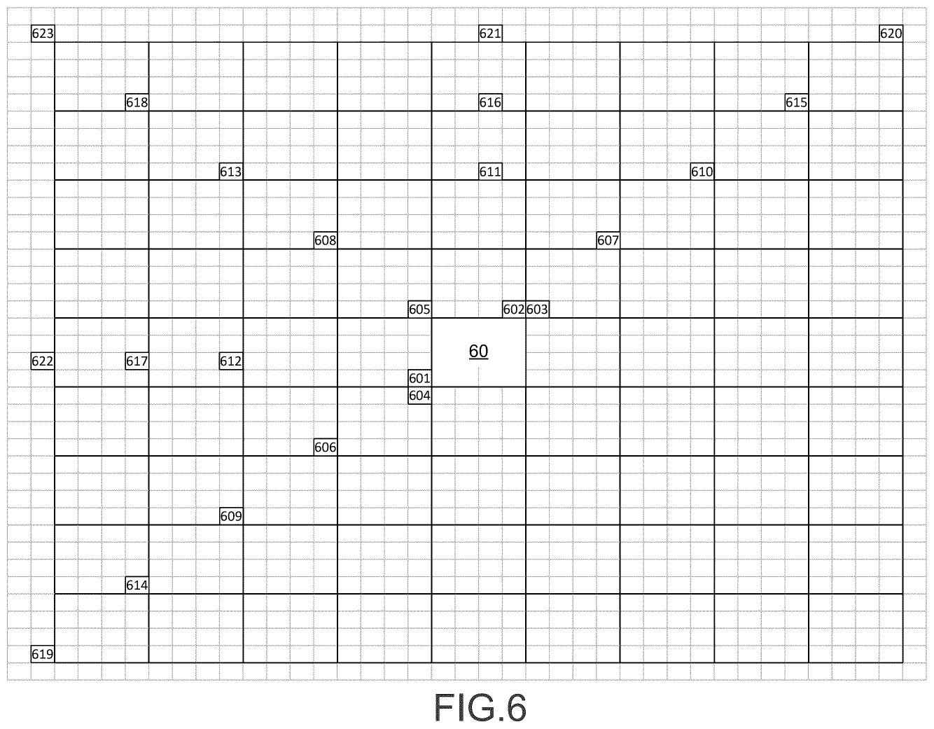

FIG. 5 is a diagram illustrating multiple adjacent blocks of a block unit, in accordance with one or more example implementations of this disclosure. FIG. 6 is a diagram illustrating multiple adjacent and non-adjacent blocks of a block unit, in accordance with one or more example implementations of this disclosure.

As FIG. 5 shows, in some implementations, adjacent blocks of the block unit 50 may include a top block 51, a left block 52, a top-right block 53, a bottom-left block 54, and a top-left block 55. The position of the top-left corner of the block unit 50 may be (x, y), the width of the block unit 50 may be W, and the height of the block unit 50 may be H, where W and H are positive integers. The top block 51 may be a block including a sample located at (x+W−1, y−1), the left block 52 may be a block including a sample located at (x−1, y+H−1), the top-right block 53 may be a block including a sample located at (x+W, y−1), the bottom-left block 54 may be a block including a sample located at (x−1, y+H), and the top-left block 55 may be a block including a sample located at (x−1, y−1).

As shown in FIG. 6, in some implementations, blocks 601 to 605 may be the adjacent blocks of the block unit 60, and blocks 606 to 623 may be the non-adjacent blocks of the block unit 60. The distances between the non-adjacent coded blocks 606 to 623 and the block unit 60 may be determined based on the width and height of block unit 60.

However, the definition of neighboring blocks (e.g., including adjacent blocks and/or non-adjacent blocks) of a block unit is not limited to that described with reference to FIGS. 5 and 6. A person of ordinary skill in the art may adopt different definitions as needed, e.g., depending on the coding standard or implementation.

In some implementations, the first neighboring block of the block unit may be selected from the neighboring blocks of the block unit based on the TM costs. Specifically, the decoder module 124 may calculate a TM cost for each of the neighboring blocks of the block unit, and may select the first neighboring block that corresponds to the smallest TM cost.

More specifically, each neighboring block of the block unit may provide a motion/block vector which points to a collocated block of the block unit in a reference/current frame. A TM cost may then be calculated based on reconstructed samples in a template region of the block unit and reconstruction samples in a template region of the collocated block. The neighboring block that corresponds to the smallest TM cost may be selected, as the first neighboring block, for determining the initial guide vector that indicates the first reference block in the first reference frame. In some implementations, the template region of a block may include reconstructed samples from the above and/or left of the block, forming a template such as an L-shaped region.

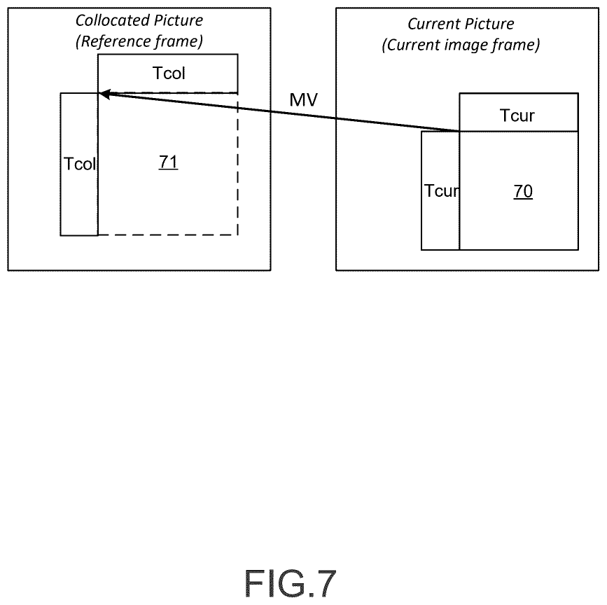

FIG. 7 illustrates how a template matching cost for a neighboring block of a block unit is calculated, in accordance with one or more example implementations of this disclosure.

As shown in FIG. 7, a neighboring block (e.g., one of the neighboring blocks shown in FIGS. 5 and 6) of the block unit 70 may provide a motion vector (MV) that points to a collocated block 71 in a collocated picture (e.g., a reference frame). A current template Tour, including reconstructed samples from a neighboring region (e.g., to the above and/or to the left) of the block unit, may be compared with a reference template Tcol for the collocated block 71. The collocated block 71 may be determined in the collocated picture by applying the motion vector MV to the position of the block unit. The reference template Tcol may include reconstructed samples from a neighboring region (e.g., to the above and/or to the left) of the collocated block 71. For example, the TM cost for the neighboring block (e.g., the left block 52) may be calculated as the sum of absolute differences (SAD) between the current template Tour and the reference template Tcol.

Taking FIG. 4, as an example, the first neighboring block 41 of the block unit 40 may be selected and the block/motion vector MV1 of the first neighboring block 41 may serve, as the initial guide vector, because the first neighboring block 41 may correspond to the smallest TM cost, among all neighboring blocks of the block unit 40.

In some implementations, the TM cost may be used for determining the motion vector in each layer. Taking FIG. 4, as an example, the motion vector MV1 may point to a first block in the first reference frame 410, and the TM cost may be calculated for each neighboring block of the first block. The neighboring block, of the first block, that corresponds to the smallest TM cost, may then be selected, as the first reference block, and the motion vector MV2 provided by (e.g., associated with) the first reference block may be used for the layer associated with the first reference frame 410.

In some implementations, the TM cost may be used for determining the motion vector in the last layer. Taking FIG. 4, as an example, the motion vector MV2 may point to a second block in the second reference frame 420, and the TM cost may be calculated for each neighboring block of the second block. The neighboring block, of the second block, that corresponds to the smallest TM cost, may then be selected, as the second reference block, and the motion vector MV3 provided by (e.g., associated with) the second reference block may be used for the (last) layer associated with the second reference frame 420.

In some implementations, multiple motion shifts may be determined for a block unit by utilizing motion information from multiple neighboring blocks. Each neighboring block may provide a distinct initial guide vector, such as a motion vector or block vector, to locate a reference block in a reference frame, initiating a recursive process to identify subsequent reference blocks across multiple reference frames. Each motion shift may indicate a collocated block for the block unit. In some implementations, the determined motion shifts may be included in a candidate list of an inter-prediction mode, such as the SbTMVP mode described in VVC or ECM. In some implementations, a reference index indicating each neighboring block of the block unit may be added to the candidate list with the corresponding motion shift.

For example, a first neighboring block of a block unit may provide a first initial guide vector that is used to determine a first reference block in a first reference frame. The motion vector of the first reference block may be used to determine a second reference block in a second reference frame. This process may continue recursively to determine additional reference blocks. The motion shift for the first neighboring block may be calculated, as the vector sum of the motion vectors of the reference blocks, determined from the first neighboring block. Similarly, a second neighboring block may provide a second initial guide vector that is used to determine a third reference block in a third reference frame, followed by recursive determination of additional reference blocks to calculate a distinct motion shift, as the vector sum of the motion vectors of the reference blocks, determined from the second neighboring block. The determination of each motion shift follows the same methods or implementations, as above-described implementations/methods for the first neighboring block, and thus is not repeated here again. This approach may be extended to additional neighboring blocks, including spatial or temporal, adjacent or non-adjacent, blocks to derive multiple motion shifts for the block unit.

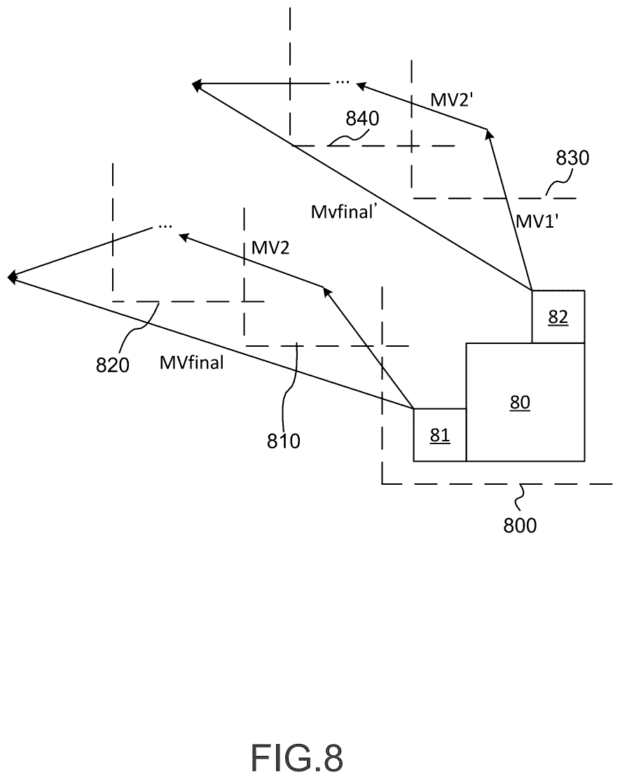

FIG. 8 is a diagram illustrating a determination of multiple motion shifts for a block unit, in accordance with one or more example implementations of this disclosure.

As shown in FIG. 8, a block unit 80 in a current image frame 800 may be associated with multiple neighboring blocks (e.g., neighboring blocks shown in FIGS. 5 and 6) each providing a distinct initial guide vector to determine a motion shift. For example, a first neighboring block 81, located at the left side of the block unit 80, may provide a first initial guide vector MV1 that is used to determine a first reference block in a first reference frame 810. The motion vector MV2 of the first reference block may be used to determine a second reference block in a second reference frame 820, and the motion shift MVfinal for the first neighboring block 81 of the block unit 80 may be determined as the vector sum of the vectors MV1, MV2. Any additional motion vectors from further reference blocks may be determined recursively. Similarly, a second neighboring block 82, located above the block unit 80, may provide a second initial guide vector MV1′ that is used to determine a third reference block in a third reference frame 830. The motion vector MV2′ of the third reference block may be used to determine a fourth reference block in a fourth reference frame 840, and the motion shift MVfinal′ for the second neighboring block 82 of the block unit 80 may be determined as the vector sum of the vectors MV1′, MV2′. Any additional motion vectors from further reference blocks may be determined recursively. This process may be extended to additional neighboring blocks, including spatial or temporal, adjacent or non-adjacent, blocks to generate multiple motion shifts for the block unit 80.

Referring back to FIG. 3, at block 340, the method/process 300 may determine (e.g., by the decoder module 124) a plurality of predicted samples of the block unit based on the motion information of the collocated block. Specifically, a prediction of (each sample in) the block unit may be determined.

In some implementations, the motion information of the collocated block indicated by a motion shift of the block unit may be used for predicting the (samples in) block unit.

In some implementations, the motion shift(s) of the block unit may be included in the candidate list of an inter-prediction mode, and at least one of the candidates in the candidate list may be used for predicting the (samples in) block unit.

In some implementations, the inter-prediction mode may be the SbTMVP mode, and a motion shift may be selected from the candidate list. A motion field may be determined at a subblock level based on the motion information of the collocated block indicated by the motion shift. The prediction of samples in the block unit (also referred to as the predicted samples of the block unit) may be determined by using the motion field based on the SbTMVP mode. Specifically, the block unit and the collocated block may be divided into multiple (e.g., 8*8=64) subblocks, respectively. Samples in each subblock of the block unit may be predicted based on the motion information (e.g., motion vector(s)) of the corresponding subblock of the collocated block.

At block 350, the method/process 300 may reconstruct (e.g., by the decoder module 124) the block unit based on the predicted samples of the block unit.

In some implementations, the decoder module 124 may add multiple residual components to the predicted samples of the block unit (e.g., the prediction of the samples in the block unit determined at block 340) to reconstruct the block unit. The residual components may be determined from the bitstream.

Once the block unit is reconstructed, the method/process 300 may then end. By repeating the method/process 300, multiple block units may be reconstructed and, as a result, the multiple image frames included in the video data may be reconstructed accordingly.

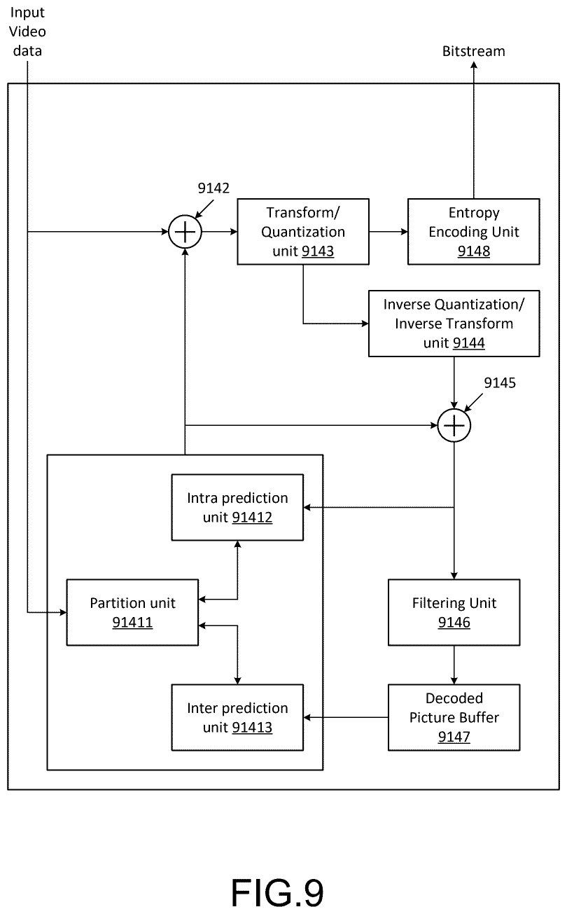

FIG. 9 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 9141), at least a first summer (e.g., a first summer 9142) and a second summer (e.g., a second summer 9145), a transform/quantization processor (e.g., a transform/quantization unit 9143), an inverse quantization/inverse transform processor (e.g., an inverse quantization/inverse transform unit 9144), a filter (e.g., a filtering unit 9146), a decoded picture buffer (e.g., a decoded picture buffer 9147), and an entropy encoder (e.g., an entropy encoding unit 9148). The prediction processing unit 9141 of the encoder module 114 may further include a partition processor (e.g., a partition unit 91411), an intra prediction processor (e.g., an intra prediction unit 91412), and an inter prediction processor (e.g., an inter prediction unit 91413).

The encoder module 114 may receive the source video and encode the source video to output a bitstream. The encoder module 114 may receive source video including multiple image frames and then divide the image frames according to a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 9141 may receive a current image block of a specific one of the image frames. The current image block may be the luminance block or one of the chrominance blocks in the specific image frame.

The partition unit 91411 may divide the current image block into multiple block units. The intra prediction unit 91412 may perform intra-predictive coding of a current block unit relative to one or more neighboring blocks in the same frame as the current block unit in order to provide spatial prediction. The inter prediction unit 91413 may perform inter-predictive coding of the current block unit relative to one or more blocks in one or more reference image blocks to provide temporal prediction.

The prediction processing unit 9141 may select one of the coding results generated by the intra prediction unit 91412 and the inter prediction unit 91413 based on a mode selection method, such as a cost function. The mode selection method may be a rate-distortion optimization (RDO) process.

The prediction processing unit 9141 may determine the selected coding result and provide a predicted block corresponding to the selected coding result to the first summer 9142 for generating a residual block and to the second summer 9145 for reconstructing the encoded block unit. The prediction processing unit 9141 may further provide syntax elements, such as motion vectors, intra-mode indicators, partition information, and/or other syntax information, to the entropy encoding unit 9148.

The intra prediction unit 91412 may intra-predict the current block unit. The intra prediction unit 91412 may determine an intra prediction mode directed toward a reconstructed sample neighboring the current block unit in order to encode the current block unit.

The intra prediction unit 91412 may encode the current block unit using various intra prediction modes. The intra prediction unit 91412 of the prediction processing unit 9141 may select an appropriate intra prediction mode from the selected modes. The intra prediction unit 91412 may encode the current block unit using a cross-component prediction mode to predict one of the two chroma components of the current block unit based on the luma components of the current block unit. The intra prediction unit 91412 may predict a first one of the two chroma components of the current block unit based on the second of the two chroma components of the current block unit.

The inter prediction unit 91413 may inter-predict the current block unit as an alternative to the intra prediction performed by the intra prediction unit 91412. The inter prediction unit 91413 may perform motion estimation to estimate motion of the current block unit for generating a motion vector.

The motion vector may indicate a displacement of the current block unit within the current image block relative to a reference block unit within a reference image block. The inter prediction unit 91413 may receive at least one reference image block stored in the decoded picture buffer 9147 and estimate the motion based on the received reference image blocks to generate the motion vector.

The first summer 9142 may generate the residual block by subtracting the prediction block determined by the prediction processing unit 9141 from the original current block unit. The first summer 9142 may represent the component or components that perform this subtraction.

The transform/quantization unit (143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 9143 may perform a scan of the matrix including the quantized transform coefficients. Alternatively, the entropy encoding unit 9148 may perform the scan.

The entropy encoding unit 9148 may receive multiple syntax elements from the prediction processing unit 9141 and the transform/quantization unit (143, including a quantization parameter, transform data, motion vectors, intra modes, partition information, and/or other syntax information. The entropy encoding unit 9148 may encode the syntax elements into the bitstream.

The entropy encoding unit 9148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 9144 may apply inverse quantization and inverse transformation to reconstruct the residual block in the pixel domain for later use as a reference block. The second summer 9145 may add the reconstructed residual block to the prediction block provided by the prediction processing unit 9141 in order to produce a reconstructed block for storage in the decoded picture buffer 9147.

The filtering unit 9146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 9145.

The decoded picture buffer 9147 may be a reference picture memory that stores the reference block to be used by the encoder module 114 to encode video, such as in intra-coding or inter-coding modes. The decoded picture buffer 9147 may include a variety of memory devices, such as DRAM (e.g., including SDRAM), MRAM, RRAM, or other types of memory devices. The decoded picture buffer 9147 may be on-chip with other components of the encoder module 114 or off-chip relative to those components.

The method/process 300 for decoding/encoding video data may be performed by the first electronic device 110. The encoder module 114 may receive the video data. The video data received by the encoder module 114 may be a video. The encoder module 114 may determine a block unit from an image frame based on the video data. The encoder module 114 may divide the image frame to generate multiple CTUs, and further divide one of the CTUs to determine the block unit according to one of multiple partition schemes based on any video coding standard.

With respect to the block unit, the encoder module 114 may determine, based on a vector sum of multiple motion vectors of multiple reference blocks, a motion shift that indicates a collocated block for the block unit. Details for determining the motion shift(s) are described above (e.g., as illustrated with block 330 of FIG. 3) and therefore are not repeated herein.

The encoder module 114 may use the method/process 300 to determine predicted samples of the block unit based on the motion information of the collocated block, and to further reconstruct the block unit based on the predicted samples of the block unit. Details for determining the prediction for the block unit are described above (e.g., as shown in block 340 of FIG. 3) and therefore are not repeated herein. The reconstructed block unit may include multiple reconstructed samples, which may be used as references for predicting subsequent blocks in the video data.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. An electronic device for decoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit from an image frame based on the video data;
determine, based on a vector sum of a plurality of motion vectors of a plurality of reference blocks, a motion shift that indicates a collocated block for the block unit;
determine a plurality of predicted samples of the block unit based on motion information of the collocated block; and
reconstruct the block unit based on the plurality of predicted samples of the block unit.

2. The electronic device of claim 1, wherein determining the motion shift comprises:
determine a first neighboring block spatially or temporally neighboring the block unit;
determine a first set of reference blocks, among the plurality of reference blocks, based on motion information of the first neighboring block; and
determine the motion shift based on a first set of motion vectors of the first set of reference blocks.

3. The electronic device of claim 2, wherein determining the first neighboring block comprises:
calculating a plurality of template matching costs of a plurality of neighboring blocks of the block unit; and
selecting the first neighboring block from the plurality of neighboring blocks, such that the first neighboring block is associated with a smallest template matching cost among the plurality of template matching costs.

4. The electronic device of claim 2, wherein the motion information of the first neighboring block comprises a block vector.

5. The electronic device of claim 2, wherein determining the first neighboring block comprises:
selecting the first neighboring block from a plurality of adjacent blocks of the block unit and a plurality of non-adjacent blocks of the block unit.

6. The electronic device of claim 2, wherein determining the motion shift further comprises:
determine a second neighboring block spatially or temporarily neighboring the block unit;
determine a second set of reference blocks, among the plurality of reference blocks, based on the motion information of the second neighboring block; and
determine the motion shift based on the first set of motion vectors of the first plurality of reference blocks and a second set of motion vectors of the second set of reference blocks.

7. The electronic device of claim 2, wherein determining the first set of reference blocks comprises:
determining a first reference block, among the first set of reference blocks, based on the motion information of the first neighboring block; and
determining a second reference block, among the first set of reference blocks, based on a first motion vector, among the first plurality of motion vectors, of the first reference block.

8. The electronic device of claim 7, wherein:
the first reference block is determined by performing a template matching method based on the first neighboring block and the motion information of the first neighboring block, and
the second reference block is determined by performing the template matching method based on the first reference block and the first motion vector.

9. The electronic device of claim 1, wherein determining the plurality of predicted samples of the block unit based on motion information of the collocated block comprises:
determining, based on the motion information of the collocated block, a motion field at a subblock level; and
determining the plurality of predicted samples of the block unit based on a subblock-based temporal motion vector prediction method and the motion field.

10. An electronic device for encoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit from an image frame based on the video data;
determine, based on a vector sum of a plurality of motion vectors of a plurality of reference blocks, a motion shift that indicates a collocated block for the block unit;
determine a plurality of predicted samples of the block unit based on motion information of the collocated block; and
reconstruct the block unit based on the plurality of predicted samples of the block unit.

11. The electronic device of claim 10, wherein determining the motion shift comprises:
determine a first neighboring block spatially or temporally neighboring the block unit;
determine a first set of reference blocks, among the plurality of reference blocks, based on motion information of the first neighboring block; and
determine the motion shift based on a first set of motion vectors of the first set of reference blocks.

12. The electronic device of claim 11, wherein determining the first neighboring block comprises:
calculating a plurality of template matching costs of a plurality of neighboring blocks of the block unit; and
selecting the first neighboring block from the plurality of neighboring blocks, such that the first neighboring block is associated with a smallest template matching cost among the plurality of template matching costs.

13. The electronic device of claim 11, wherein the motion information of the first neighboring block comprises a block vector.

14. The electronic device of claim 11, wherein determining the first neighboring block comprises:
selecting the first neighboring block from a plurality of adjacent blocks of the block unit and a plurality of non-adjacent blocks of the block unit.

15. The electronic device of claim 11, wherein determining the motion shift further comprises:
determine a second neighboring block spatially or temporarily neighboring the block unit;
determine a second set of reference blocks, among the plurality of reference blocks, based on the motion information of the second neighboring block; and
determine the motion shift based on the first set of motion vectors of the first plurality of reference blocks and a second set of motion vectors of the second set of reference blocks.

16. The electronic device of claim 11, wherein determining the first set of reference blocks comprises:
determining a first reference block, among the first set of reference blocks, based on the motion information of the first neighboring block; and
determining a second reference block, among the first set of reference blocks, based on a first motion vector, among the first plurality of motion vectors, of the first reference block.

17. The electronic device of claim 16, wherein:
the first reference block is determined by performing a template matching method based on the first neighboring block and the motion information of the first neighboring block, and
the second reference block is determined by performing the template matching method based on the first reference block and the first motion vector.

18. The electronic device of claim 10, wherein determining the plurality of predicted samples of the block unit based on motion information of the collocated block comprises:
determining, based on the motion information of the collocated block, a motion field at a subblock level; and
determining the plurality of predicted samples of the block unit based on a subblock-based temporal motion vector prediction method and the motion field.

19. A non-transitory machine-readable medium of an electronic device storing one or more computer-executable instructions for decoding video data, the one or more computer-executable instructions, when executed by at least one processor of the electronic device, causing the electronic device to:
receive the video data;
determine a block unit from an image frame based on the video data;
determine, based on a vector sum of a plurality of motion vectors of a plurality of reference blocks, a motion shift that indicates a collocated block for the block unit;
determine a plurality of predicted samples of the block unit based on motion information of the collocated block; and
reconstruct the block unit based on the plurality of predicted samples of the block unit.
